(19) United States
(12) Patent Application Publication
(10) Pub. No.: US 2010/0182507 A1
(43) Pub. Date: Jul. 22, 2010

(54) METHOD AND APPARATUS FOR USING A COLOR INDICATOR TO DISPLAY FREQUENCY OR CHANNEL SELECTION

(75) Inventors: John R. Haggis, San Jose, CA (US); Martin Cohen, Hatboro, PA (US); Arthur L. Cohen, Cupertino, CA (US); Francis Lau, Fremont, CA (US)

Correspondence Address: STAINBROOK & STAINBROOK, LLP, 412 AVIATION BOULEVARD, SUITE H, SANTA ROSA, CA, 95403, US

(73) Assignee: AERIELLE TECHNOLOGIES, INC., Mountain View, CA (US)

(21) Appl. No.: 12/596,227

(22) PCT Filed: Apr. 17, 2008
(86) PCT No.: PCT/US08/60667

§ 371 Date: Mar. 25, 2010

Related U.S. Application Data
(60) Provisional application No. 60/912,386, filed on Apr. 17, 2007.

(51) Int. Cl. H04N 5/50

(52) U.S. Cl. 348/570; 348/E07.001

(57) ABSTRACT

A system for matching the currently tuned frequency of a signal transmitting device with that of a signal receiving device, including a transmitter having an illuminated color display which changes colors in relation to the channel or frequency on which the transmitter is currently tuned, and a signal receiving device having an illuminated color display which changes colors in relation to the channel or frequency on which the signal receiving unit is currently tuned. Each device has a channel selector function so that the frequency to which the device is tuned can be changed, thereby changing the color displayed.

### BACKGROUND OF THE INVENTION

1. Technical Field

The present invention relates most generally to consumer electronic devices, and more particularly to means for indicating channel or frequency selection, and still more particularly to a method and apparatus for using color as the exclusive means for indicating a channel or frequency in use on a multimedia playback device or other electronic device for transmitting audio and/or video files from a transmitting device to a receiving device.

2. Background Art

Typical transmitter and receiver devices allow a user to select a frequency on which to transmit or receive signals. An example would be a handheld walkie-talkie system, in which one can select one of a multitude of transmit or receive frequencies. Each frequency is indicated, for example, by a number from 0 to 9. Each of the frequency selections are actual hard coded transmit frequencies and are duplicated in the receiving unit. Thus, setting the transmitter and the receiver to the same frequency will allow for one-way and two-way communications.

Wireless baseband communication systems use different carrier frequencies to transport separate streams simultaneously between different transmitters and receivers. These different frequencies create different “channels” for simultaneous use in the same region of the frequency spectrum. Similarly, spread-spectrum systems that use frequency hopping are essentially baseband signals that hop around a given band. These systems also achieve different virtual “channels” by grouping the hopping frequencies in different limited regions of the band, and further by using divergent hopping tables for different channels so as to avoid conflicts when they overlap the same region of the band. Communications carried through broadband media may use virtual channels for the same reasons, in the context of broadcast (or narrowcast) media streams.

In all these cases, wireless transmission systems use different frequencies and/or sequences to compose channels among which a user can select to avoid interference with another transmission. Traditionally, such equipment has used numeric displays to indicate frequency or channel by numbers or letters. Numeric display types span the range from mechanical switches with painted or etched channel labels (numbers or letters) at each stop of an indicator, or electronic displays (electro-mechanical or optical—LED, LCD, etc.) that form an image of numbers or letters.

In the consumer electronics industry, it is increasingly popular to provide users with the ability to customize their personal electronic products. This may take the form of changing a display screen background color or picture, adding an extra layer of colored rubber as a protective sleeve, or applying a graphic adhesive to change the appearance of the device. Despite such customization schemes, there are no known prior art devices, or documents describing possible devices, in which there is shown a way for a user to tailor a device to display a selected color for indicating the frequency at which he or she is transmitting a signal. The present invention provides a method and apparatus for achieving this end.

### DISCLOSURE OF INVENTION

The present invention is a method and apparatus for employing color display alone to indicate the currently tuned channel or frequency selected on any device. The various objects and advantages of the inventive method and apparatus are easily understood and appreciated when considering the inventive system as being integrated in an audio-sharing unit. An audio-sharing unit is a new type of consumer product that allows users to share compact disk (CD) quality audio in real time. The application of such a device involves the use of two or more identical audio-sharing units, each with its own RF transceiver. An audio-sharing unit, when in transmit mode, transmits an RF signal modulated with audio from the transmitting unit's source input (a music source, such as a CD or MP3 player). One or more other identical audio-sharing units (when in receive mode, and in range of the transmitting audio-sharing unit) receive and demodulate the transmitted signal. This allows two or more users to simultaneously listen to the same audio source. The transmitting user can also listen to the source through a local headphone jack.

In the inventive method of indicating a frequency selection of the present invention, the audio-sharing unit employs a novel kind of frequency allocation, wherein color indications do not correspond to actual frequencies in the RF band. Instead, each color channel can assume any physical RF frequency and is differentiated by the transmitter, which tags each packet of data sent to the receiver. The receiver thus will only receive the given packet if it matches the same color channel it is set to receive.

It is therefore an object of the present invention to provide means to use color to display the currently-tuned channel on any device;

It is another object of the present invention to provide a frequency/channel indicator that is visible from a distance.

It is still another object to provide a frequency/channel indicator usable by people who are sight-impaired.

A further object is to provide a frequency/channel indicator that is usable with the transmitting device in any orientation (upside-down, sideways).

A still further object is to provide a frequency/channel indicator usable by people who are illiterate with Arabic numerals.

Yet another object of the present invention is to provide a frequency/channel indicator that expands the dimensions of experience in using transmission media by invoking emotion and identity in connection with certain colors representing certain channels.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram showing the principal components of n audio-sharing device which employs the method and apparatus of the present invention;

FIGS. 2A and 2B comprise a high-level flowchart showing the main functions performed by the software in the CPU of the audio-sharing device;

FIG. 3 is a high-level flowchart showing the automatic power-off routines performed by the software in the CPU;

FIG. 4 is a drawing showing a human eye comparing the brightness of a blinking LED with that of an LED that is always on;

FIG. 5 is a high-level flowchart showing the automatic LED management routines performed by the software in the CPU;

FIG. 6 is a conceptual diagram showing a color channel mapping to a physical RF frequency;

FIG. 7 is a schematic block diagram showing a first preferred embodiment for incorporating the inventive color indicator to display frequency or channel selection into a consumer electronic device;

FIG. 8 is a schematic block diagram showing a second preferred embodiment thereof;

FIG. 9 is a schematic block diagram showing a third preferred embodiment thereof;

FIG. 10 is a schematic block diagram view showing a fourth preferred embodiment thereof; and

FIG. 11 is a schematic block diagram view showing a fifth preferred embodiment of the inventive system and method.

### BEST MODE FOR CARRYING OUT THE INVENTION

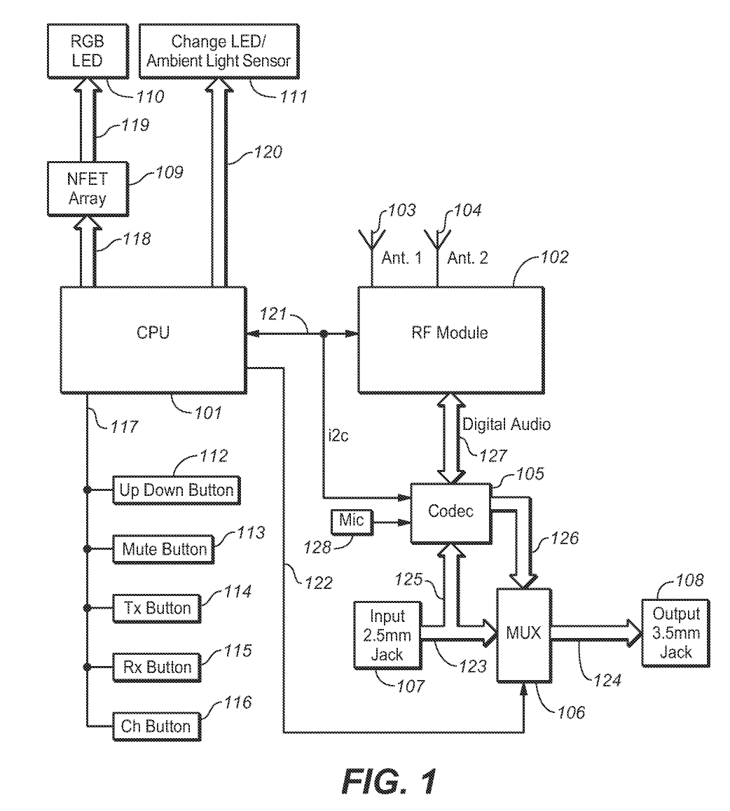

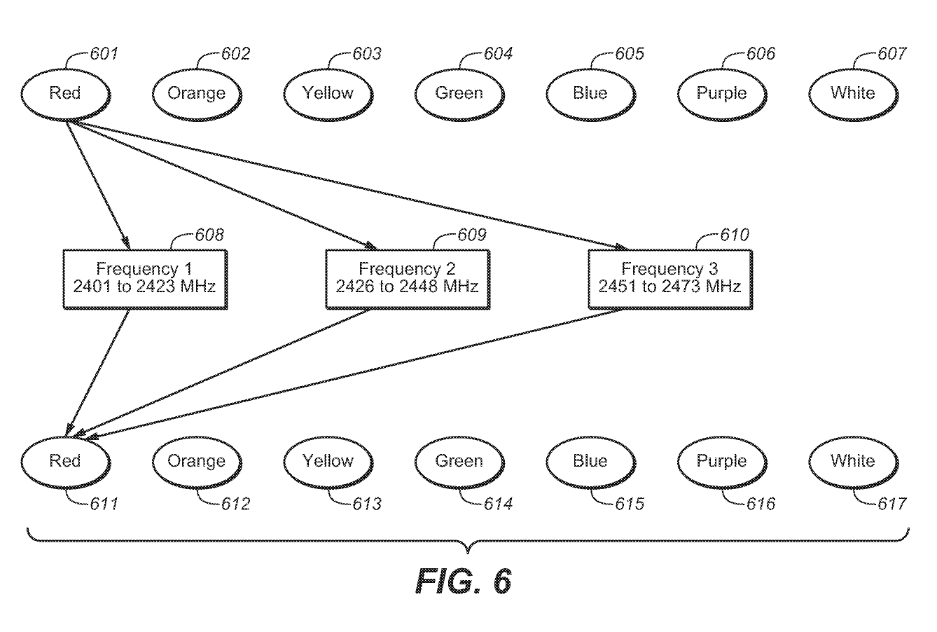

Referring to FIGS. 1 through 11, wherein like reference numerals refer to like components in the various views, there is illustrated therein a new and improved method and apparatus for using a color indicator for displaying a channel or frequency selection.

Turning first to FIGS. 1 through 6, there is shown an audio-sharing device for wired and/or wireless transfer of digital content and/or data between multimedia players, which consists of several interconnected subsystems. Such a device is an ideal implementation of the color display/frequency-indicating system of the present invention. In an exemplary audio-sharing unit, invented and designed by the present applicant, a central processing unit (CPU) CPU 101 controls the overall behavior of the audio-processing unit. CPU 101 is connected to N-channel FET array 109 via control bus 118. Control bus 118 is used by CPU 101 to control N-channel FET array 109, and thereby RGB LED assembly 110. RGB LED assembly 110 is connected to the N-channel FET array 109 via wiring bus 119.

CPU 101 controls charge LED 111 via charge control bus 120. Charge control bus 120 is a bi-directional bus that allows CPU 101 to control the illumination of charge LED 111 as well as allowing CPU 101 to detect ambient light conditions by way of charge LED 111.

CPU 101 scans and monitors the conditions of the user interface buttons (Up/Down button 112, Mute button 113, Tx button 114, Rx button 115 and Ch button 116) via scan bus 117.

CPU 101 controls multiplexer (MUX) 106 via MUX control bus 122. CPU 101 uses MUX 106 to route audio between input jack 107, codec 105 and output jack 108. Audio received via input jack 107 is connected directly to the input of the codec 105 via analog audio path 125 through analog audio path 123. The audio going to the output of the output jack 108 can be routed under the control of CPU 101. By selection of the MUX 106 input, one can choose either the audio from the input jack 107 or the audio out of the codec 105 to be routed to output jack 108 via analog audio path 124. Codec 105 has an analog input that is always connected to input jack via analog audio path 125.

CPU 101 communicates with RF module 102 via I²C bus 121. RF module 102 is an RF transceiver with an integrated digital packet and link manager for managing digital data transmission and receipt via the RF link. The internal transmitter of RF module 102 is connected to antenna 103, and the internal receiver of RF module 102 is connected to antenna 103 and antenna 104 in a diversity antenna scheme. The CPU 101 may extract digital song information from a music player via a digital connection and communicate this information to the RF module 102 via I²C bus. The information can then be sent over a data link and received by the receiving RF module. When the CPU 101 in a receiver receives this information, the information is stored in the internal memory of CPU 101.

When used as a receiver, RF module 102 communicates digital information (including the digital representation of the received audio) to codec 105 via digital audio bus 127. When used as a transmitter, RF module 102 receives digital information (including the digital representation of the transmit audio) from codec 105 via digital audio bus 127. Codec 105 is primarily used to convert analog signals to digital data, and to convert digital data into analog signals. Codec 105 receives analog signals from the input jack 107 via analog interface 125 and 123, as well as from microphone 128, which is connected directly to an analog input of codec 105.

CPU 101 controls the activities of codec 105 via I²C bus 121. For instance, CPU 101, when the audio-sharing unit is in transmit mode and the user presses Mute button 113, causes codec 105 to mute the analog signal received from the input jack 107 via analog interface 125 and 123 and simultaneously cause codec 105 to accept analog input from microphone 128 so that the microphone audio is sent to RF module 102 via digital audio bus 127. In another instance, when the audio-sharing unit is in receive mode and the user presses Mute button 113, CPU 101 causes codec 105 to mute the analog audio being sent via analog path 126, through MUX 106, and analog path 124 to output jack 108.

CPU 101 performs the initial setup of RF module 102 and codec 105 via i2c bus 121. i2c bus 121 is a well-known 3-wire bus configuration and protocol typically used for serial transfer of data between digital components, such as CPUs and digital signal processors (DSPs). CPU 101 also handles interrupts raised by RF module 102. CPU 101, during normal operation, continuously senses the condition of each of the user interface buttons (Up/Down button 112, Mute button 113, Tx button 114, Rx button 115 and Ch button 116), and controls the user interface RGB LED assembly 110 illumination. CPU 101 accomplishes power management during normal operation by judiciously turning on and off certain components of the audio-sharing unit.

On power up, CPU 101 initializes the audio-sharing unit as a whole. The initialization consists of configuring RF module 102, MUX 106, codec 105, charge LED 111 and RGB LED assembly 110. Immediately after the initialization of the audio-sharing unit is completed, the software operating on CPU 101 begins a continuous polling loop to check the condition of each of the user interface buttons. When the user presses one of the user interface buttons, the software operating on CPU 101 activates a corresponding function of the audio-sharing unit.

The wireless subsystem of the audio-sharing unit is RF module 102. RF module 102 handles all the RF protocols needed to transmit wireless data packets from one audio-sharing unit to another. RF module 102 also contains the radio transceiver circuitry used to transmit and receive the RF signals modulated with those data packets. The activities of RF module 102 are directed by CPU 101, in terms of whether to transmit or receive, and on which RF channel to operate.

The interactive user interface to the audio-sharing unit includes a set of user interface buttons (that are continuously monitored by CPU 101) and RGB LED assembly 110 controlled by CPU 101 by way of N-channel field effect transistor (FET) array 109. RGB LED assembly 110 is controllable in terms of brightness and output color.

CPU 101 manages RGB LED assembly 110 in a novel manner, resulting in dramatic power savings during the operation of the audio-sharing unit, as described in greater detail later in this disclosure.

Overall, the user interface is designed to provide a simple, intuitive interface that is easy to understand and operate. Each of the individual user interface buttons is described below.

Up/Down button 112 is preferably part of a jog dial switch. When in receive mode, up/down button 112 is used to change the output audio volume to the headset connected to the audio-sharing unit at output jack 108. For user comfort and safety reasons, in transmit mode, up/down button 112 is not used for adjusting the volume of the transmitted audio. In the transmit mode, volume adjustment for the local headset is done via the media player itself. An automatic gain control (AGC) is used in codec 105 to keep the transmitted audio signal modulation at a set level. By using the AGC in this manner, the audio volume remains relatively constant at the receiving end even when the transmitting media player's volume is varied between 10%-100% of its maximum volume. This is an important feature, since it prevents the transmitting audio-sharing unit from adjusting the volume of the listener's earphones to an uncomfortable level, leaving volume control of the receiving audio-sharing unit in the hands of its user.

In addition, the receiver will emit audible beeps corresponding to the audio level as it is changed. Given this, the user will notice that the audio is turned up exceptionally high even when the source audio in the transmitter is muted. Therefore, the audible beeps adds yet another level of protection for the user using a receiver.

Mute button 113 is preferably located at the center of a jog dial switch. The internal actions related to depressing Mute button 113 depend on the mode in which the audio-sharing unit is operating (transmit, receive, or ‘off’ mode).

When the audio-sharing unit is in transmit mode and the user presses Mute button 113, CPU 101 causes codec 105 to mute the analog signal received from input jack 107 via analog interface 125 and 123 and simultaneously cause codec 105 to accept analog input from microphone 128 so that the microphone audio is sent to RF module 102 via digital audio bus 127. This allows the user of the transmitting audio-sharing unit to talk to all listeners while the connected source audio is muted. In an alternative embodiment, the user of the transmitting audio-sharing unit can also mix the source audio connected at input jack 107 with their voice (through microphone 128) in real time so that any listeners hear both simultaneously.

When the audio-sharing unit is in receive mode and the user presses Mute button 113, CPU 101 causes codec 105 to mute the analog audio being sent via analog path 126 to external headphones or an external amplifier connected at output jack 108.

When the audio-sharing unit is in walkie-talkie mode, when Mute button 113 is pressed, CPU 101 routes the audio output from microphone 128 through codec 105, where the analog audio is digitized, and the digitized audio is then sent into the modulator input of RF module 102. CPU 101 then turns on the transmitter in RF module 102. In this mode, when Mute button 113 is released, CPU 101 switches RF module 102 to receive mode. At this point, the digitized audio output of the demodulator in RF module 102 that is passed via digital audio interface 127 to the digital input of codec 105, and is converted from digital data to analog signals in codec 105, is sent by codec 105 to output jack 108 through MUX 106. In this manner, the user can now listen to any signals transmitted by other audio-sharing units. The received audio is muted until RF module 102 signals CPU 101 that received RF and demodulated data (digitized audio) are both present. When received RF and demodulated data are both present, CPU 101 instructs codec 105 to un-mute the received audio.

Depressing and holding Mute button 113 for one second while in the transmit or receive mode will cause the CPU 101 to switch into low-power mode. Depressing and holding the Mute button 113 for one second while in low-power mode will wake the unit up to the default receive mode.

Tx button 114 is depressed to toggle the mode of the audio-sharing unit from receive to transmit. When CPU 101 detects that Tx button 114 has been depressed, CPU 101 instructs RF module 102 to monitor the available RF channels and select the best channel on which to transmit. Once this selection is complete, CPU 101 configures RF module 102 to operate on the selected Color channel, and turns on the transmitter inside RF module 102. Then CPU 101 sets the analog signal level of the AGC in the codec 105 to a fixed value to insure that the transmitted audio level is not too high. After this, CPU 101 configures MUX 106 to route the analog signal received at input jack 107 to the analog output jack 108 as a means of passing through the audio while in transmit mode. In this manner, the audio received from the connected audio source is fed to the input of Codec 105 and passed to the modulator input of RF module 102 and be modulated onto the transmitted RF signal. CPU 101 then generates a beep tone sequence in the headphones locally connected to output jack 108, and sets the color of RGB LED assembly 110 based on the selected color channel to let the user know that the unit is transmitting and is on the selected channel. If the audio-sharing unit is waking up from the low power sleep mode, then CPU 101 blinks charge LED 111 in a sequence indicating the charge state of the battery.

While the audio-sharing unit is in transmit mode, CPU 101 instructs MUX 106 to route the audio received at input jack 107 to the headphones connected at output jack 108, as well as tap off the source to feed the same audio into the analog input of codec 105. Codec 105 converts the audio into digital data and passes the data to RF module 102 via digital audio interface 127. The digital audio received by RF module 102 is packetized and then modulated onto the transmitted RF signal.

Depressing Rx button 115 causes CPU 101 to direct RF module 102 to switch to receive mode and begin receiving RF signals on the currently selected Color channel. The user of the audio-sharing unit can determine upon which RF channel the unit is receiving by observing the color of RGB LED assembly 110 (a different color is displayed for each channel).

While in receive mode, the audio retrieved from the data packets that are demodulated from the received RF signal is routed from RF module 102 to codec 105 via digital audio interface 127. The analog output of codec 105 is connected via analog path 126 to the headphones connected at output jack 108. In this manner, the user can listen to the audio being received by the audio-sharing unit via the RF link. In receive mode, audio signal from input jack 107 is blocked at MUX 106 but will still be present at the input of the Codec 105. In this case, the codec 105 will ignore this signal.

Regardless of whether the audio-sharing unit is in transmit mode or receive mode, each time Ch button 116 is depressed and released, CPU 101 causes RGB LED assembly 110 to step to the next color in a 7-color sequence of red, orange, yellow, green, blue, violet and white (discussed more fully below). Each color denotes a Color channel on which RF module 102 can receive and transmit. When Ch button 116 has remained un-pressed for a predetermined amount of time, CPU 101 causes RF module 102 to tune to the Color channel denoted by the color selected by the user. If operating in transmit mode, RF module 102 begins transmitting on the selected Color channel If operating in receive mode, RF module 102 begins receiving on the selected Color channel.

The channel selection and RGB LED assembly 110 color remain the same when switching from the transmit mode to the receive mode, and vice versa. When the audio-sharing unit is switched to walkie-talkie mode, the channel on which it is operating remains unchanged until the user manually selects another channel Additionally, the channel selection is stored in local non-volatile memory, and thus remains the same after powering the audio-sharing unit off and then on again.

Radio systems typically have an upper limit to the number of simultaneous communication channels available in a given frequency spectrum. In a 2.4 GHz implementation using the RF module, there is a hard limitation on the number of frequency channels that can be used. In this case, there are only three non-overlapping channels at 2.412 GHz 608, 2.437 GHz 609, and 2.462 GHz 610 each with a bandwidth of 22 MHz. However, due to the pulsed nature of the transmission, it is possible to time multiplex more than one channel into a single frequency. That is, given that the duty cycle is around 10%, it is theoretically possible to obtain 10 channels if the multiplexing is completely synchronous.

The present invention provides a way for a user to select a color display for indicating the frequency at which he or she is transmitting. This is realized by altering the color of a RGB LED to represent the different ‘channel colors’. A mapping problem arises when we have more ‘channel colors’ than there are actual non-overlapping frequencies.

In the system of the present invention, there are seven (7) color channels available: Red, Orange, Yellow, Green, Blue, Purple, and White. However, the operative concept remains the same when more colors are integrated or different representations of a channel are interleaved into the way the channels are represented.

Hence, the mapping issue can be described in a mathematical formula as follows (Frequency shortened to ‘Freq’): {Red 601, Orange 602, Yellow 603, Green 604, Blue 605, Purple 606, White 607} ε A, A={Freq 1 608, Freq 2 609, Freq 3 610}.

There are several possible ways to map this, one of which is to set Red Channel 601 to be hard coded to Freq 1 608, Orange Channel 602 to Freq 2 609, Yellow Channel 603 to Freq 3 610, and Green Channel 604 to Freq 1 608 again and so on. This will generally work if the transmitter and receiver pair comprise the only users of this frequency band. Since this is not generally the case, due to the fact that the spectrum is the in same frequency allocation as WiFi and Bluetooth devices in the unlicensed band, using this scheme will invariably result in a large amount of interference with the devices. While this may meet FCC regulations, it is a highly undesirable feature. Given that if the units were able detect the usage of a particular frequency and disable that channel color, it will render that color channel unusable and give a negative user experience.

A more agile way is to implement a non-hardcode frequency allocation scheme. This requires the transmitter to search for the best frequency channel first by looking at the usage on that channel This is accomplished by either reading the RSSI (received signal strength indication) or by detecting a carrier on that frequency. The transmitter will then transmit on that ‘best’ frequency and then allow the receiver to find the transmitter. This in effect will map any ‘color channel’ 601 through 607 to any frequency available 608 through 610. Thus, any ‘color channel’ can use any particular frequency at any time depending on signal conditions.

The hardware implementation also allows for adaptive frequency usage. When a currently using frequency channel degrades performance to a certain threshold, it will scan the RF spectrum and find another frequency channel to use. The negotiations are implemented at the ASIC level such that the transmitter and receiver will negotiate the frequency change without a drop out in audio. All this switching is thus completely transparent to the user. The end result is an emulated seven (7) virtual channels that can be used. The limitation will be reached only if there are simultaneous transmitters within the same broadcast range. Hence, when all of the available bandwidth is occupied, interference may start to occur due to overlapping transmitters.

Using this scheme, the receiver will then have the problem of figuring out which frequency belongs to which transmitting ‘color channel’. This is accomplished by a hardware specific configuration marked by a specific ID on every transmission packet. This ID is transmitted with every data burst and is included in every single header of every transmission. Thus a receiver wanting to receive one of the channels will scan all of the frequencies looking for a matching ID as well as the color channel.

In short, the system proceeds as follows: (1) The user selects ones of seven virtual color channels to transmit; (2) the transmitter turns on and searches for a free frequency among the three possible frequencies; (3) frequency X is found to be free and the transmitter starts transmitting; (4) each packet is transmitted with an ID unique to that color channel; (5) another user turns on a receiving unit matching the virtual color channel of the transmitter; (6) the receiver scans all frequencies checking for the same ID that is unique to that color channel; (7) when a match is found, the transmitter and receiver pair will synchronize.

Thus, the virtualization of channels allows one to hide the details of manually allocating a clear frequency channel for usage. The virtualization also improves aesthetics in this application by allowing more color channels to be chosen while having a fixed number of hard frequencies. Without virtualization, one will only be able to assign a maximum of three colors, one to each frequency. This of course will severely limit the actual colors possible and reduce the appeal of the product overall.

Since the transmitters are transmitting in pulsed mode, it is possible to time multiplex the data stream such that there is minimal interference between two transmitters transmitting on the same frequency. Given this method, each of the three frequencies can allow for more than one channel to coexist. The above of virtualization still holds as we can treat these multiplexed channels as if they are non-overlapping frequencies.

The method of data encryption in the audio-sharing unit is a standard 128-bit XOR scrambling. When encryption is enabled, everything but the header information in the transmitted data packets is scrambled. The header information is left unscrambled to facilitate synchronizing the transmitter and receivers.

In order to prevent the product from being cloned by other manufacturers, the 128-bit pattern is created in such a way as to allow the pattern to be copyrighted for this application.

To do this, a company logo is used as a basis for the copyright. It is drawn into an 11×12 pixel picture where a filled in pixel represents a 1 in a bit pattern. The pattern is then read from top left, left to right, all the way to the bottom right. This code is then formed into a 128-bit string by ignoring the contents of the last four bits. This picture of the company logo is then readily copyrighted and hence any communications between any two of the present invention's audio-sharing units are protected against copyright infringements.

The transceiver in RF module 102 operates in the 2.4 GHz band. It uses a protocol proprietary to the RF module. While RF module 102 utilizes some of the same 2.4 GHz spectrum as well-known ‘WiFi’ devices, the audio-sharing unit does not use the same protocol as WiFi devices, and therefore cannot communicate with a WiFi device.

In the United States, there are currently only 13 usable channels in the 2.4 GHz band. However, only three of these are non-overlapping channels. The audio-sharing unit is limited to only transmitting on these three non-overlapping channels. Thus, the theoretical limit is to have three communication channels in use within the same area.

Often, however, this limit will not be reached. When more than one of the available channels is not in use locally, the audio-sharing unit can select a channel from the pool of available channels in real time. In this case, there is a pool of three channels. By scanning the available channels and detecting the received RF signal strength on each channel, the audio-sharing unit determines which channel is best for local use (will least likely experience interference from another RF source). The audio-sharing unit is then operated on the selected channel This auto-detection is performed when the user presses Tx button 114 and every time a new Color channel is selected.

The audio-sharing unit has an auto-off function. This is accomplished using hardware embedded in RF module 102 intended for switching the RF module into a low power mode. However, in the audio-sharing application, the low power mode of RF module 102 does not satisfy the low power requirements of the system. Thus, CPU 101 senses information from RF module 102 in order to determine whether to power off the audio-sharing unit by cutting power off to RF module 102.

RF module 102 is configured to interrupt CPU 101 at a predefined interval of approximately 125 milliseconds, or 8 times a second. When RF module 102 in transmit mode has sensed that the audio level has been below the trigger level for 2400 of these intervals, the CPU 101 will initiate an auto-off sequence. The 2400 intervals is equivalent to 5 minutes of delay. Upon auto-off, the CPU will remove power to the RF module, configure the codec for low-power mode as well as set the internal registers in the CPU 101 for low-power mode.

When the audio-sharing unit is turned off, power is turned back on when CPU 101 detects that a user has continuously pressed the Mute button 113 for 1 second.

Auto-off in the receiver is accomplished in a different manor. Due to hardware limitations, the receiver is not able to sense the audio levels coming from the transmitter. Instead, a RF synchronization bit is used instead. Essentially, this method relies on the transmitter to auto-off first which allows the receiver to sense a loss in RF synchronization. A time out period of 2 minutes is put in to sense the auto-off of the transmitter. Thus, from the audio turning off initially to the turn-off time of a receiver is actually 5+2 minutes.

Of course, since there may be intermittent loss of RF synchronization even when the transmitter is present, the timeout period will reset as soon as RF synchronization is obtained. Thus the 2 minute time is a sort of buffer to avoid faulty auto-off situations.

It is often the case when a listener hears a song they enjoy, they would like to purchase the song and own it for themselves. The audio-sharing unit will facilitate the purchase of a song that was heard via the audio-sharing unit's receiver.

The audio-sharing unit accepts audio from a media player via input jack 107. This audio is broadcasted in uncompressed digital format from a transmitting audio-sharing unit to a receiving audio-sharing unit. The receiving audio-sharing unit can do one of 3 things to extract the song title information. The user pressing a specific predetermined button sequence triggers one of the actions below. Otherwise, the trigger can be fully automatic which equates to initiating one of the actions every time a new song is played: (a) Record (uncompressed) a small section of the received digitized analog signal, and then transfer it to a separate computer for analysis; (2) record a compressed version of a sample of the received digitized audio, and then transfer the recorded sample to a separate computer for analysis; or (3) use an embedded form of digital song title extraction software and record only the song title and artist in plain text.

Since the audio-sharing unit is a small battery operated device, it is best to offload the audio to a computing process on a more powerful computer system for analysis. Also, it is beneficial to offload the audio to a computer system that has an Internet connection. This is so that the software analyzing the small section of the song can pass the audio to a website (or websites) on the Internet that can identify songs (even those published very recently) based on a small sample of audio from the song.

In some audio-sharing devices of the kind described above, the CPU 101 may digitally interface with a media player's processor. When linked this way the CPU 101 can extract the actual song title, artist and genre in digital form from the media player's processor. In this configuration, the transmitting audio-sharing unit broadcasts this song information data at regular intervals over the wireless data link to a receiving audio-sharing unit. Therefore, in this embodiment, the process of analyzing the audio for the artist and title is rendered irrelevant. The present invention provides a way for a user to select a color display for indicating the frequency at which he or she is transmitting. This is realized by altering the color of a RGB LED to represent the different ‘channel colors’. A mapping problem arises when we have more ‘channel colors’ than there are actual non-overlapping frequencies.

In the system of the present invention, there are seven (7) color channels available: Red, Orange, Yellow, Green, Blue, Purple, and White. However, the operative concept remains the same when more colors are integrated or different representations of a channel are interleaved into the way the channels are represented.

Hence, the mapping issue can be described in a mathematical formula as follows (Frequency shortened to ‘Freq’): {Red 601, Orange 602, Yellow 603, Green 604, Blue 605, Purple 606, White 607} ε A, A={Freq 1 608, Freq 2 609, Freq 3 610}.

There are several possible ways to map this, one of which is to set Red Channel 601 to be hard coded to Freq 1 608, Orange Channel 602 to Freq 2 609, Yellow Channel 603 to Freq 3 610, and Green Channel 604 to Freq 1 608 again and so on. This will generally work if the transmitter and receiver pair comprise the only users of this frequency band. Since this is not generally the case, due to the fact that the spectrum is the in same frequency allocation as WiFi and Bluetooth devices in the unlicensed band, using this scheme will invariably result in a large amount of interference with the devices. While this may meet FCC regulations, it is a highly undesirable feature. Given that if the units were able detect the usage of a particular frequency and disable that channel color, it will render that color channel unusable and give a negative user experience.

A more agile way is to implement a non-hardcode frequency allocation scheme. This requires the transmitter to search for the best frequency channel first by looking at the usage on that channel This is accomplished by either reading the RSSI (received signal strength indication) or by detecting a carrier on that frequency. The transmitter will then transmit on that ‘best’ frequency and then allow the receiver to find the transmitter. This in effect will map any ‘color channel’ 601 through 607 to any frequency available 608 through 610. Thus, any ‘color channel’ can use any particular frequency at any time depending on signal conditions.

The hardware implementation also allows for adaptive frequency usage. When a currently using frequency channel degrades performance to a certain threshold, it will scan the RF spectrum and find another frequency channel to use. The negotiations are implemented at the ASIC level such that the transmitter and receiver will negotiate the frequency change without a drop out in audio. All this switching is thus completely transparent to the user. The end result is an emulated seven (7) virtual channels that can be used. The limitation will be reached only if there are simultaneous transmitters within the same broadcast range. Hence, when all of the available bandwidth is occupied, interference may start to occur due to overlapping transmitters.

Using this scheme, the receiver will then have the problem of figuring out which frequency belongs to which transmitting ‘color channel’. This is accomplished by a hardware specific configuration marked by a specific ID on every transmission packet. This ID is transmitted with every data burst and is included in every single header of every transmission. Thus a receiver wanting to receive one of the channels will scan all of the frequencies looking for a matching ID as well as the color channel

In short, the system proceeds as follows: (1) The user selects ones of seven virtual color channels to transmit; (2) the transmitter turns on and searches for a free frequency among the three possible frequencies; (3) frequency X is found to be free and the transmitter starts transmitting; (4) each packet is transmitted with an ID unique to that color channel; (5) another user turns on a receiving unit matching the virtual color channel of the transmitter; (6) the receiver scans all frequencies checking for the same ID that is unique to that color channel; (7) when a match is found, the transmitter and receiver pair will synchronize.

Thus, the virtualization of channels allows one to hide the details of manually allocating a clear frequency channel for usage. The virtualization also improves aesthetics in this application by allowing more color channels to be chosen while having a fixed number of hard frequencies. Without virtualization, one will only be able to assign a maximum of three colors, one to each frequency. This of course will severely limit the actual colors possible and reduce the appeal of the product overall.

The receiving audio-sharing unit receives this song title information regularly and the data is saved to a file on the audio-sharing unit when the listener presses a specific button sequence or depending on the implementation, it will record the audio at regular intervals. The stored information can then be uploaded onto a computer that runs analysis software to allow easy viewing of the titles of received songs. The analysis software then offers various choices of ways in which the user can purchase the song.

RGB LED Assembly: A 1-millisecond interrupt timer in CPU 101 triggers the software routine in CPU 101 that manages RGB LED assembly 110 in the audio-sharing unit. The main function of RGB LED assembly 110 is to display the color of the channel on which the audio-sharing unit is currently operating. The instant disclosure relates to a seven color scheme. Accordingly, the color displayed will be one of those seven colors.

When the audio-sharing unit is transmitting, RGB LED assembly 110 will appear to be continuously on for 800 ms and off for 200 milliseconds in a repeating cycle. When the audio-sharing unit is receiving, RGB LED assembly 110 will appear to stay on continuously.

An LED element of the Charge LED assembly 111, when it is not being used as an indicator, is configured as a light sensor. The information from this sensor can then be used to auto-adjust the brightness of RGB LED assembly 110. Use of an LED as a light sensor is not new art, and is demonstrated in past issues of various trade publications, and most notably in a demonstration circuit board available through Texas Instruments.

Charge LED 111 is used to indicate the battery charge condition. Charge LED 111 is also used to detect the ambient light at the surface of the audio-sharing unit. In this way CPU 101 determines the brightness to which RGB LED assembly 110 should be auto-adjusted. Charge LED 111 is controlled directly by CPU 101.

Power Saving Based On Persistence of Vision: Persistence of vision is a well-known phenomenon that is relied upon by many industries. For instance, movie producers are aware of this phenomenon. It was long ago discovered that a certain period of a full black frame must be used in between the displays of consecutive picture frames of a movie in order to create a moving picture. During the black image, though nothing is visible, the human brain perceives this as the last image seen and hence ‘persists’ the image. Without the black frame, the movie will look blurred and choppy.

Consumer electronics manufacturers are also aware of this phenomenon. As an example, the ‘swinging’ LED lights that appear to suspend an image in mid air take advantage of persistence of vision. An LED on the swinging arm will briefly blink at the moment it arrives at certain location in free space. When the same LED arrives again in that same spot, it will blink there once again. Since the brain will ‘persist’ the vision of each blink of this LED, the point in space at which the LED is repeatedly illuminated will appear to the human eye as a solid light point (not blinking) suspended in mid air.

In some studies it has been found that, for a typical person, certain light frequencies will tend to persist for a longer period of time than other light frequencies. However, the present invention does not take this into account. It has been discovered that treating all colors as if they persist the same amount of time is sufficient for the purposes of the present invention. Since the typical human starts to notice ‘flickering’ when the blink (refresh) rate of an LED is below 60 Hz, the typical refresh rate in the power savings context will be 60 Hz or greater.

Since the human eye and brain can be ‘tricked’ into perceiving that there is a constant light appearing while not having to constantly illuminate the light source, the present invention takes advantage of this fact to reduce power consumption in RGB LED assembly 110. At least some conservation of battery power is accomplished by setting the duty cycle of the blinking LED to less than 100%.

The operational variables for RGB LED assembly 110 are: (a) the duration of time the LED is turned on; (b) the duration of time the LED is turned off; (c) the current draw while the LED is on.

Due to manufacturing variances and other factors, before an LED is operated and observed, it is not known how long or how fast to blink an LED to realize power savings while maintaining the same brightness as when the LED is constantly on (not blinking)

In order to determine the best blink rate and duty cycle to use for achieving maximum conservation of battery power during normal operation of the audio-sharing unit, RGB LED assembly 110 of the present invention is configured at the factory using the process described below.

Referring now to FIG. 4, to perform the LED configuration task, a person uses his or her eye 401 to compare a blinking (pulsed) LED 402 (the LED being tested) to an LED 404 that is constantly on (the benchmark LED) in order to qualitatively compare the brightness between two LEDs. Only a human tester can make this make this comparison, since the effective brightness needs to be perceived by the human vision system, where the persistence of vision phenomenon is in effect. In this testing and configuration, the light 403 emitted from pulsed LED 402, and the light 405 emitted from constant on LED 404 are compared to see whether the pulsed LED 402 appears to be the same brightness as the constant on LED 404.

The blinking LED is operated in each desired color configuration, with a set of blink rates from 60 Hz to 1 kHz. For each color configuration, at each blink rate in the set, the blinking LED is operated with a set of duty cycles from 1% to 10% ‘LED on’ duty cycle. At each duty cycle in the set, the current through the blinking LED is raised until the brightness of the blinking LED is equal to that of the non-blinking LED. Since using a lower duty cycle will require a higher current pulse, care must be taken not to exceed the instantaneous maximum current rating of the LED or its driving power source otherwise the lifetime and reliability of the RGB LED will deteriorate. The test results are stored in a digital ‘current steering’ table that is then transferred to the memory of CPU 101 in the audio-sharing device into which the specific RGB LED assembly 102 will be incorporated. CPU 101 uses this table during normal operation to determine the correct amount of current and the correct duty cycle to apply to the specific LEDs in order to maintain uniform brightness while minimizing power usage.

The results of the testing described above indicate that a 60 Hz blink rate will create a good efficiency and the power savings of using an LED this way will cause close to a 50% reduction on total power usage to display an LED with the same brightness. The same can be done with a higher blink rate as well. The essence of this aspect of the present invention is to reduce power consumption (by blinking the LED at the most efficient frequency with the most efficient duty cycle) while maintaining the same perceived brightness from the LED as is perceived when the LED is constantly on.

This method of the present invention can be applied to any slowly varying LED display. However, this method is not appropriate for rapidly changing LED displays, such as video. Any LED that needs to appear as constantly illuminated can be blinked in this manner to achieve a better average current consumption in the circuit in which the LED resides.

In the United States and many other countries, in order to realize the energy savings of LED usage versus incandescent lamps, municipalities are converting their vehicular traffic signals to LED light sources as quickly as practical. In particular, the green and red lights are being replaced in signal lights, since these are the lamps that are on most of the time. Application of the power saving method related to RGB LED assembly 110 of the present invention in the LED versions of the vehicular signal lights could result in significant overall power savings for the municipalities in which the signals are operated, and the aggregate energy savings across all of these municipalities word-wide would be substantial.

As seen in FIG. 1, RGB LED assembly 110 is driven by a current steering system consisting of N-channel FET array 109. In the interface via wiring bus 119 between RGB LED assembly 110 and N-channel FET array 109, two FETs are connected to each LED in RGB LED assembly 110, and each FET is set to drive a certain current when turned on. One will drive a low current while the other will drive a high current. Depending on the control currents applied to their bases, the combination of the two FETs can produce either a ‘totally’ off state in the LED, or a very high current pulse through the LED. Each of the LEDs in RGB LED assembly 110 has this drive arrangement. CPU 101 controls the current flowing through each of the FET bases in N-channel FET array 109. CPU 101 sets these values, along with the duty cycle, for each LED in RGB LED assembly 110 according to the values stored in the current steering table. This allows CPU 101 to turn on a certain LED in RGB LED assembly 110 to a certain color and brightness using the current steering look-up table.

The audio-sharing unit includes an on-board battery charger system that preferably uses a typical lithium ion charger chip that includes features such as short circuit charging, pre-charging, as well as a user-specifiable charge current. The batteries of the audio-sharing unit are rechargeable ‘button’ batteries.

In many low quality electronic devices, the indicated battery level is often incorrectly displayed. For example, a device may display ‘100% charged’ for a brief moment, and then jump down to ‘75% charged’, even though the battery may still have 99% of its charge. In short, the display is not properly calibrated to the true charge remaining in the battery.

In order to pre-calibrate the display to the battery's remaining charge in the factory, the battery is characterized by running a series of load tests to measure its discharge current and actual voltage on the battery throughout its discharge cycle. The results of this test series are stored in the memory of CPU 101 of the audio-sharing unit in which the characterized battery is installed. In order to display the most correct reading while the unit is being used, CPU 101 uses a discharge curve corresponding to the current load on the battery to calculate the remaining battery charge based on the voltage present at the battery terminals.

Even though, in the test environment, a certain voltage equates to the battery's remaining charge, the measurement circuitry used to read the battery voltage during normal operation can add a small load to the battery. In order to accurately read the battery voltage without drawing excessive steady state current, a high impedance voltage divider with 1% values on the order of mega ohms is used. The divider divides down the voltage to a safe level for CPU 101 while using the full range of the internal analog-to-digital converter (ADC) of CPU 101.

The actual voltage reading at the input of CPU 101 needs to be calibrated as well. This is due to the fact that, while the input of the internal ADC of CPU 101 presents very high impedance, it will still impact the exact values used for the resistors of the voltage divider. It is necessary, therefore, to take into account the internal and parasitic resistance that will appear at the ADC input of CPU 101.

The voltage present at the battery terminals will be altered when the unit is being charged or discharged. When charging, there will be a higher voltage reading given the same remaining battery charge. If an accurate charge must be displayed while charging, CPU 101 must employ an additional battery charge curve specifically set for the charging state.

For even more accuracy when the battery is in a very discharged state, CPU 101 can also employ yet another battery charge curve for the low remaining charge state as well.

The battery charge vs. voltage may change over time as the battery starts to lose a percentage of its capacity over multiple discharge cycles. Given a certain battery, CPU 101 can note the number of times the battery has been discharged (or a fraction thereof), and follow a predefined voltage vs. capacity curve over the life of the battery. These curves are obtained beforehand in the lab and recorded into the memory accessed by CPU 101.

In an alternative embodiment, the charge display vs. actual battery charge remaining can be recalibrated in a post-manufacturing environment by having CPU 101 perform a full charge and discharge cycle on the battery. In this alternative approach, the audio-sharing unit is placed in a calibration mode as the automated procedure is followed to do a recalibration test and to store the resulting values in the memory of CPU 101.

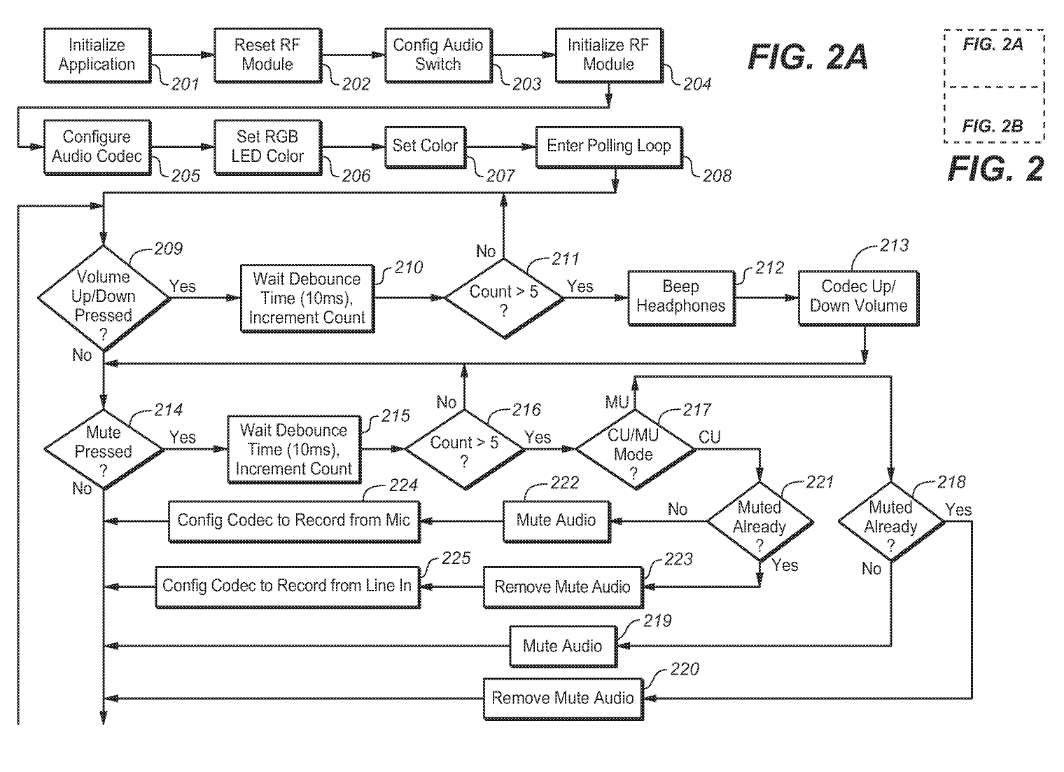

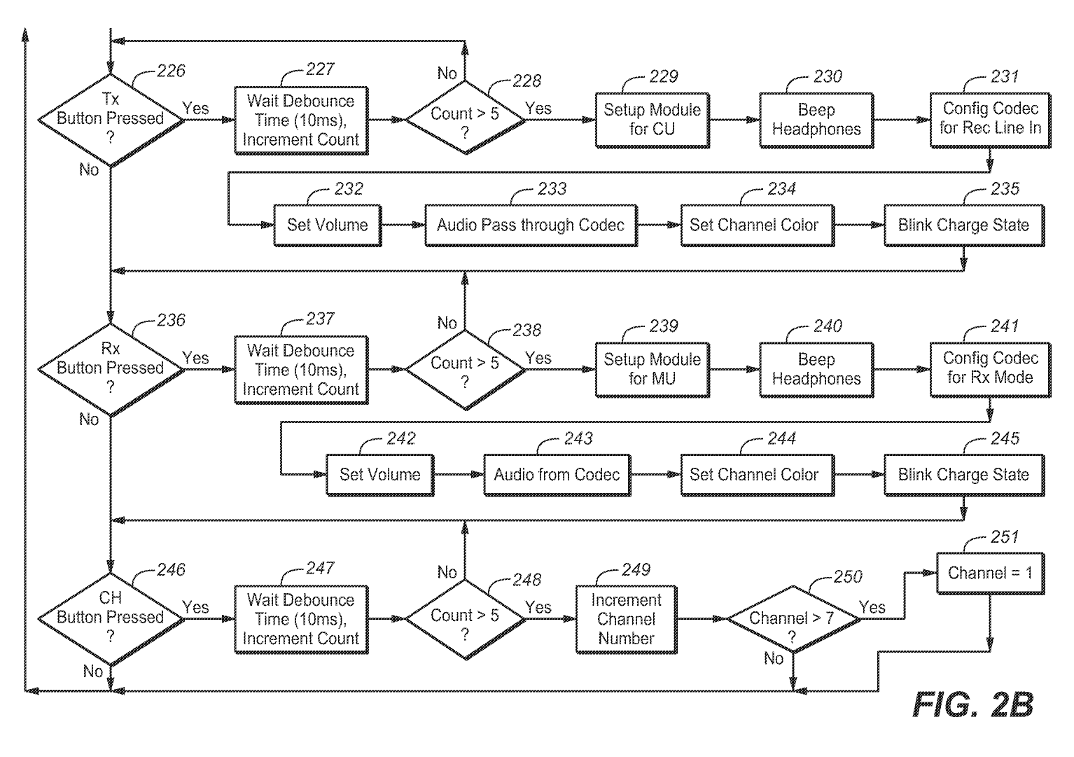

Software Flow: The software operating on CPU 101 of the audio-sharing unit controls the activities of the unit. FIG. 2 shows a high-level flowchart of this software.

In FIG. 2 it can be seen that the software starts in block 201 when the audio-processing unit is powered on. In block 201, the software initializes its internal variables, tables and communications links. Proceeding to block 202, the software resets RF module 102. Next, in block 203, the software configures the audio switch in MUX 106 to route the audio received at input jack 107 to output jack 108. Next, in block 204, the software initializes RF module 102, causing it to tune to the last used Color channel and begin receiving on that channel After this, the software proceeds to block 205 where it configures codec 105 to begin receiving and converting digitized audio from RF module 102 via digital audio interface 127. Proceeding to block 206, the software sets the color being displayed by RGB LED assembly 110. In block 207, the software sets the current color into non-volatile memory. After this, the software enters the polling loop via block 208.

Still referring to FIG. 2, it can be seen that the polling loop consists of repeatedly checking the condition of each user interface button, and then branching to an action when a button has been pressed. After the action is completed, the software returns to its last position in the polling loop, continuing from there to flow through the loop.

The polling loop begins at decision block 209. In decision block 209, if Up/Down button 112 is depressed, the software proceeds to block 210 where a de-bounce timer is run before proceeding to decision block 211 where it is determined whether the de-bounce count has exceeded 5. If the de-bounce count has exceeded 5, then the button is considered pressed, and the software proceeds to block 212. In block 212, the software beeps the headphones connected at output jack 108, and then proceeds to block 213. In block 213, the software turns volume in codec 105 up or down (depending on which side of Up/Down button 212 was depressed). When the volume has been adjusted, the software returns to the main polling loop, proceeding to decision block 214. This is where the software flows from decision block 209 when Up/Down button 212 is not depressed.

In decision block 214, if Mute button 113 is depressed, the software proceeds to block 215 where a de-bounce timer is run before proceeding to decision block 216 where it is determined whether the de-bounce count has exceeded 5. If the de-bounce count has exceeded 5, then the button is considered pressed, and the software proceeds to decision block 217.

In decision block 217, it is determined whether the audio-sharing unit is currently operating in the transmit (CU) mode or the receive mode (MU). If the unit is operating in the receive mode, the software proceeds to decision block 218 where it is determined whether the unit is already muted. If so, then the software proceeds to block 220 where the received audio mute is removed. If not, then the software proceeds to block 219 where the received audio is muted. From blocks 219 and 220, the software returns to the main polling loop, proceeding to decision block 226.

If, in decision block 217, it is determined that the audio-sharing unit is operating in the transmit mode, then the software proceeds to decision block 221. In decision block 221 it is determined whether the mute mode is already activated. If so, then the software removes the mute audio status, and turns off the audio from the local microphone. The software then proceeds to block 225 where codec 105 is configured to digitize audio received at input jack 107 and pass the digitized audio data to RF module 102 for transmission. If, in decision block 221, it is determined that the mute audio mode is not already activated, then the software proceeds to block 222, where the mute audio mode is activated (the audio received at input jack 107 is blocked). After this, the software proceeds to block 224 where codec 105 is configured to accept the analog input from microphone 128. From blocks 224 and 225, the software returns to the main polling loop, proceeding to decision block 226. Decision block 226 is where the software flows from decision block 214 if Mute button 113 is not pressed.

In decision block 226, if Tx button 114 is depressed, the software proceeds to block 227 where a de-bounce timer is run before proceeding to decision block 228 where it is determined whether the de-bounce count has exceeded 5. If the de-bounce count has exceeded 5, then the button is considered pressed, and the software proceeds to block 229.

In block 229, the software configures RF Module 102 for transmit (CU) mode, and then proceeds to block 230. In block 230, the software beeps the headphones connected at output jack 108, and then proceeds to block 231. In block 231, the software instructs MUX 106 to route the audio present at input jack 107 to the analog input of codec 105. From here, the software proceeds to block 232 where the volume of the audio passing through codec 105 is set to a fixed value, and codec 105 is instructed to maintain that volume level through the use of AGC. After this, the software proceeds to block 233 where codec 105 is instructed to digitize the received analog audio and pass the digitized audio to the digital audio input of RF module 102 for transmission. The software then proceeds to block 234 where the color displayed by RGB LED assembly 110 is set to correspond to the Color channel on which the audio-sharing unit is operating. Following this, the software proceeds to block 235 where charge LED 111 is illuminated in a series of blinks that represent the remaining charge in the battery. At this point, the software returns to the main polling loop, proceeding to decision block 236. Decision block 236 is where the software flows from decision block 226 if the Tx button 114 is not depressed.

In decision block 236, if Rx button 115 is depressed, the software proceeds to block 237 where a de-bounce timer is run before proceeding to decision block 238 where it is determined whether the de-bounce count has exceeded 5. If the de-bounce count has exceeded 5, then the button is considered pressed, and the software proceeds to block 239.

In block 239, the software configures RF Module 102 for receive (MU) mode, and then proceeds to block 240. In block 240, the software beeps the headphones connected at output jack 108, and then proceeds to block 241. In block 241, the software instructs MUX 106 to block the audio present at input jack 107, preventing the audio from reaching the headphones connected at output jack 108. From here, the software proceeds to block 242 where the volume of the audio passing through codec 105 is set to a reasonable value. After this, the software proceeds to block 243 where codec 105 is instructed to convert the received digitized audio to analog signals, and pass the analog audio to the headphones connected at output jack 108 via analog path 126. The software then proceeds to block 244 where the color displayed by RGB LED assembly 110 is set to correspond to the Color channel on which the audio-sharing unit is operating. Following this, the software proceeds to block 245 where charge LED 111 is illuminated in a series of blinks that represent the remaining charge in the battery. At this point, the software returns to the main polling loop, proceeding to block 246. Decision block 246 is where the software flows from decision block 236 if the Rx button 115 is not depressed.

In decision block 246, if Ch button 116 is depressed, the software proceeds to block 247 where a de-bounce timer is run before proceeding to decision block 248 where it is determined whether the de-bounce count has exceeded 5. If the de-bounce count has exceeded 5, then the button is considered pressed, and the software proceeds to block 249.

In block 249, the software increments the channel number and instructs RF Module 102 to begin operating on the new channel The software also sets the color of RGB LED assembly 110 to the color that correlates with the new channel number. The software then proceeds to decision block 250 where it is determined whether the channel number is greater than 7. If so, then the software proceeds to block 251 where the channel number is reset to 1, and the software returns to the main polling loop, proceeding back to decision block 209 at the top of the loop. If, in decision block 250, it is determined that the channel number is not greater than 7, then the software returns immediately to the main polling loop, proceeding back to decision block 209 at the top of the loop.

If, in decision block 246, it is determined that Ch button 116 is not being depressed, then the software returns immediately to the main polling loop, proceeding back to decision block 209 at the top of the loop.

In this manner, the software operating on CPU 101 configures and controls the audio-processing unit and continuously monitors the user interface buttons.

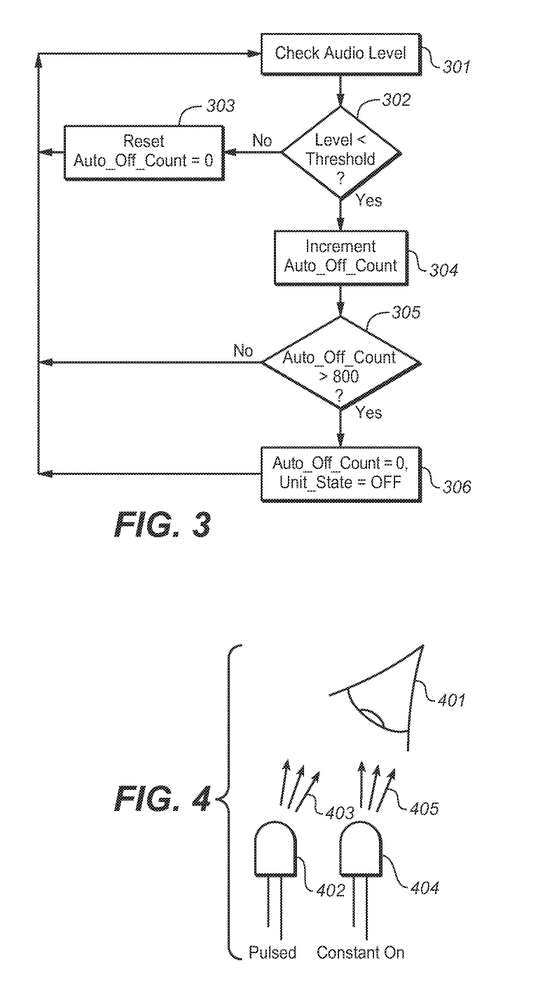

Referring next to FIG. 3, a simplified flowchart of the automated power-off routine is shown. This routine is triggered every 125 milliseconds by an interrupt set in CPU 101. The routine starts at block 301 where the amplitude level of the audio demodulated from a received RF signal is checked. The software, in decision block 302 determines whether the level is below a predetermined threshold. If not, the software proceeds to block 303 where the auto-off counter is reset to zero and the software exits this routine. If the audio is below the threshold, then the software proceeds to block 304 where the auto-off counter is incremented. The software then proceeds to decision block 305 where it is determined whether the auto-off counter has exceeded the value of 2400. If not, the software exits this procedure. If the auto-off counter has exceeded the value of 2400, then the software proceeds to block 306. In block 306, the software resets the auto-off counter to zero, and then instructs the components of the audio-sharing unit to switch to low-power mode, finally turning off the power to RF module 102. After this the software exits this routine.

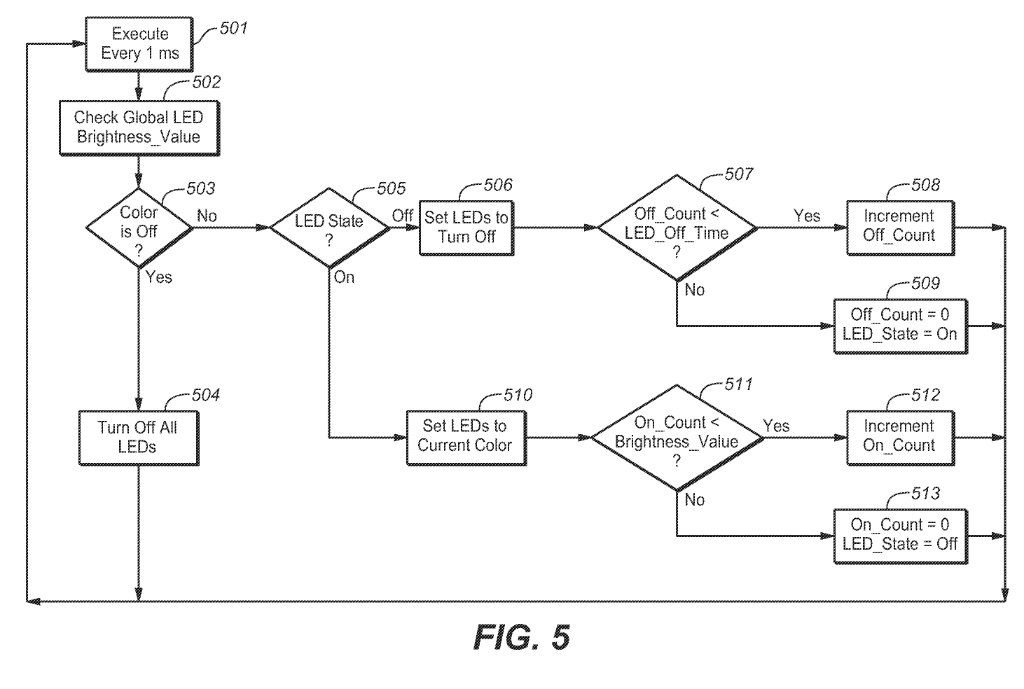

Turning next to FIG. 5, a simplified flowchart is shown of the software routine that is triggered every millisecond to control the activities of the LEDs in RGB LED assembly 110. The software enters the routine in block 501 and proceeds to block 502 where the global LED brightness value is checked. With this result, the software proceeds to decision block 503 where it is determined whether the ‘color’ to be displayed is ‘off’. If so, then the software turns off all of the LEDs and exits this routine.

If, in decision block 503, it is determined that the LEDs are not set to ‘off’, then the software proceeds to decision block 505. In decision block 505 it is assumed that the LEDs are operating in part of their on-off duty cycle, so the software determines whether the LEDs are in an ‘ON’ state or ‘OFF’ state in a duty cycle of operation. If the LEDs are in an OFF state of their duty cycle, the software proceeds to decision block 506 where it is determined if the off-counter is less than the predetermined LED off time. If so, then the software proceeds to block 508 where the off-counter is incremented, and the software exits this routine. If, in decision block 507, it is determined that the off-counter is greater than or equal to the LED off time, then the software proceeds to block 509. In block 509 the off-counter is set to zero, and the LED duty cycle state is switched to ON before the software exits this routine.

If, in decision block 505, it is determined that the LED duty cycle state is ‘ON’, the software flows to block 510. In block 510 the software sets the color displayed by RGB LED assembly 110 before proceeding to decision block 511. In decision block 511 it is determined whether the on-counter is less than the brightness value (the value of on-time in the duty cycle necessary to produce the correct level of LED brightness according to the current steering table). If so, then the software proceeds to block 512 where the on-counter is incremented before the software exits this procedure. If, in decision block 511 it is determined that the on-counter value is greater than or equal to the brightness value, then the software proceeds to block 513. In block 513, the software sets the on-counter to zero, and then switches the LED duty cycle state to OFF before exiting this routine.

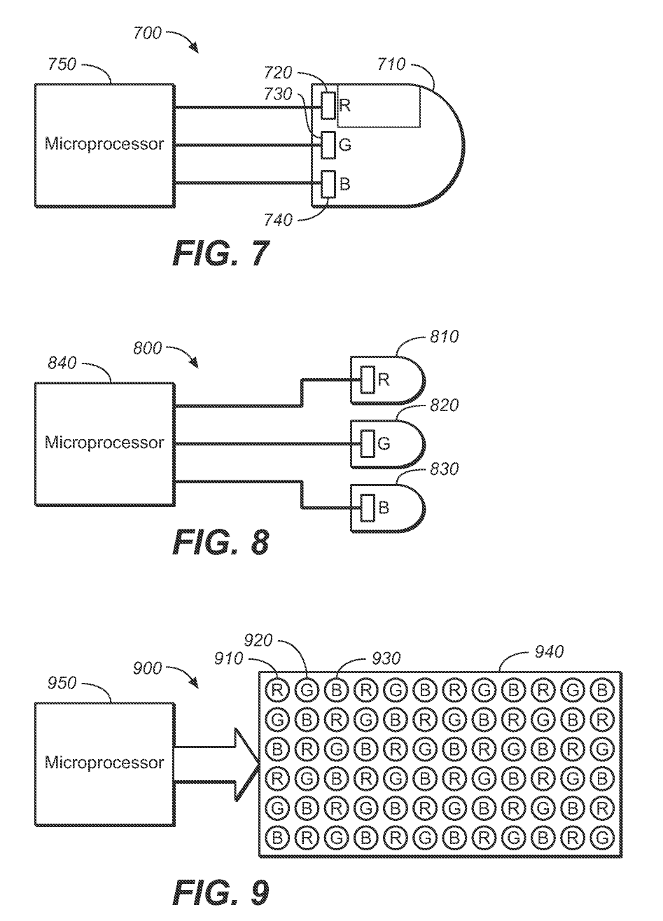

The actual color display or indicator can be physically implemented in a number of ways. Referring now to FIG. 7, in the principal and first preferred embodiment of the present invention 700, color is provided by using an RGB LED 710. This is a light-emitting diode with separate elements for red, green, and blue light, 720, 730, and 740, respectively. By controlling the selection and brightness of the different elements using the above-described microprocessor, denominated 750 in this figure, it is possible to create a wide range of primary and combinatorial colors.

In a second preferred embodiment 800, FIG. 8, and closely-related to the first embodiment, red, green, and blue LEDs 810, 820, 830, respectively, are segregated but maintained in close proximity with one another using a microprocessor 840, as above, to create the different colors.

In a third preferred embodiment, 900, FIG. 9, there is provided an array of red, green, and blue LEDs, or LED elements 910, 920, 930, on a substrate 940, the illumination in different quantity, distribution, as well as brightness of which is controlled by a microprocessor 950 to create the different colors.

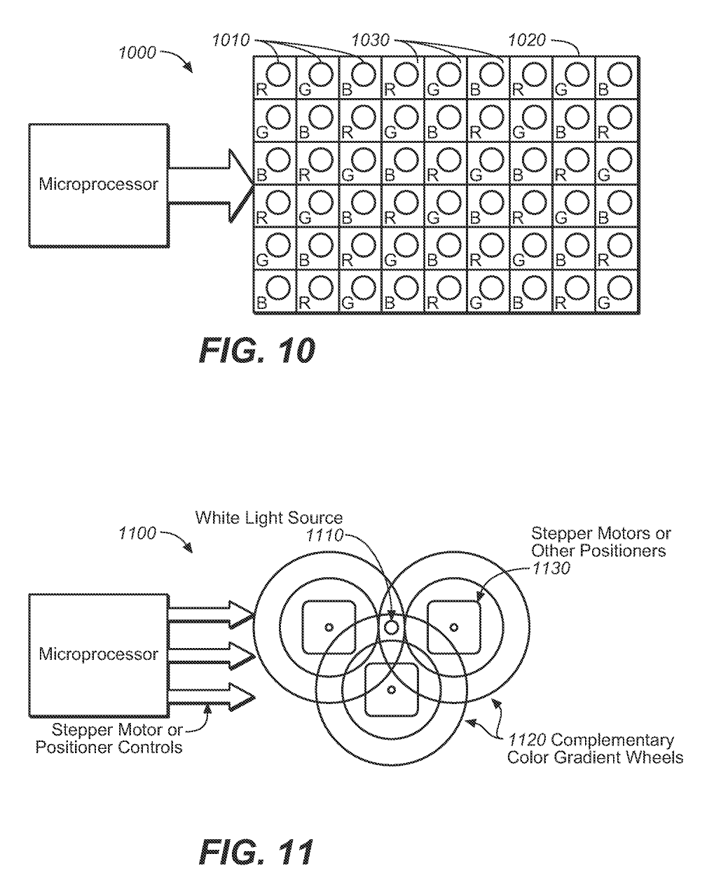

In a fourth preferred embodiment, 1000, FIG. 10, three or more white LEDs or LED elements 1010 are arranged in an array 1020 behind different color filters 1030, illuminated in different quantity, distribution, and brightness to create the different colors.

In a final and fifth preferred embodiment of the invention 1100, FIG. 11, a white light source 1110 (either LED, incandescent, fluorescent, or any other source or combination of sources) is projected through overlaid, movable color strips or wheels 1120 of complementary color filters (yellow, magenta, and cyan) with a gradation of density. Small actuators 1130 such as stepper motors having controls 1140 controlled by a microprocessor 1150 move the strips or wheels into a position where the combination of the filters at the set density levels produces the desired derivative color. The moving wheels or strips may be set manually (separately or in combination by gears, cams, pulleys, and/or belts), and the resulting movement can be detected by the microprocessor through suitable sensors, such as encoders or variable resistors (not shown, but well known in the art), in order to set the frequency or channel represented by the derivative color.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A system for matching the currently tuned frequency of a transmitter with that of a receiver, comprising:
a transmitter having an illuminated color display which changes colors in relation to the channel or frequency on which the transmitter is currently tuned, and a channel selector for changing channels and thereby changing a color displayed on said transmitter's illuminated color display; and
a receiver having an illuminated color display which changes colors in relation to the channel or frequency on which the receiver unit is currently tuned, and a channel selector for changing channels and thereby changing the color displayed on said receiver's illuminated color display.

2. The system of claim 1, wherein different colors on said illuminated color display of at least one of said signal sending unit and said signal receiving unit are indicated on a single RGB LED.

3. The system of claim 1, wherein different colors on said illuminated color display of at least one of said signal sending unit and said signal receiving unit are indicated on separate and differently colored LEDs.

4. The system of claim 1, wherein said illuminated color display is controlled by a microprocessor.

5. The transmitter of claim 1, wherein said illuminated color display of at least one of said signal sending unit and said signal receiving unit includes a light source, a plurality of movable color filters for placement over said light source and through which light from said light source is projected, and a motor for changing which of said color filters is disposed over said light source.

6. The transmitter of claim 5, wherein said motor is a micro-stepper controlled by a microprocessor.

7. A wireless digital audio and/or video file streaming system, including a transmitter and receiver, wherein color alone is used as an indicator and as a means for matching the currently-tuned channel on both of said transmitter and receiver.

8. The system of claim 7, wherein said transmitter includes a non-hardcode frequency scheme in which said transmitter searches for the best frequency channel on which to transmit, and further including means to map a channel color to any best frequency selected.

9. The system of claim 8, wherein said transmitter includes means for reading the received signal strength of transmitted signals.

10. The system of claim 9, wherein said transmitter includes hardware with a CELLID hardware configuration.

11. A method of synchronizing the frequency of a transmitter and receiver using color alone in a display scheme, said method comprising the steps of:
(a) providing a wireless digital audio file streaming system, including a transmitter and receiver, wherein color is used as a channel indicator and as a means for matching the currently-tuned channel on both the transmitter and receiver, and wherein the transmitter includes at least three possible channels for transmission, a non-hardcode frequency scheme in which the transmitter searches for the best frequency channel on which to transmit, and a mapping scheme for mapping a channel color to any best frequency selected by the transmitter;
(b) turning on the transmitter and selecting a channel color on which to transmit;
(c) searching for a free channel of the at least three available channels;
(d) finding a free frequency and commencing transmission of digital data packets;
(e) transmitting a CELLID with each digital data packet unique to each color;
(f) turning on a receiver, wherein the receiver includes a channel color indicator;
(g) matching the receiver channel color indicator to the color displayed on the transmitter;
using the receiver to scan all available transmitter broadcast channels for the same CELLID unique to the indicated color; and
(h) synchronizing the transmitter and receiver when the match is found.

12. A system for matching the currently tuned channel of a transmitter and a receiver, comprising:
a transmitter having an illuminated color display for displaying a plurality of colors, each color indicating a different Color channel;
at least one receiver having an illuminated color display for displaying a plurality of colors, each color indicating a different Color channel; and
a microprocessor-controlled color mapping scheme for mapping said Color channels to a given frequency within a predetermined frequency spectrum.

13. The system of claim 12, wherein said illuminated color display of said transmitter is a RGB LED.

14. The system of claim 12, wherein said color mapping scheme includes a finite number (n) of Color channels, each mapped to a frequency in a given frequency band having a finite number (m) of frequencies, m being a number small than n, said Color channels including: Color 1, Color 2, Color 3, Color 4, Color 5, Color 6, . . . Color n, and wherein said mapping scheme is described as: {Color 1, Color 2, Color 3, Color 4, Color 5, Color 6, . . . Color n} ε A, A={Freq 1, Freq 2, Freq 3, Freq n}, wherein Color 1 Channel is hard coded to Freq 1, Color 2 Channel to Freq 2, Color 3 Channel to Freq 3, and so forth, until the available frequencies are exhausted, at which point mapping returns to Freq 1 and continues in order through said Color n Channel.

15. The system of claim 12, wherein said color mapping scheme is a non-hardcode frequency allocation scheme.

16. The system of claim 15, wherein said non-hardcode frequency allocation scheme includes software that enables a signal sending unit to conduct a best frequency channel search for finding the best channel on which to transmit by first looking at the present usage on that channel.

17. The system of claim 16, wherein said best frequency channel search either reads a received signal strength indication or detects a carrier on that frequency, and wherein said transmitter will then transmit on that ‘best’ frequency and then allows said receiver to find said transmitter, such that any Color channel available is mapped to any frequency available, and wherein any of said Color channels can use any frequency at any time depending on signal conditions.

18. The system of claim 17, wherein said receiver determines the frequency that belongs to a transmitting Color channel using a hardware-specific configuration marked by a specific ID on every transmission from said transmitter.

19. The system of claim 18, wherein said transmitter transmits data packets and said ID is transmitted with every data burst and is included in every header of every data packet in a transmission, whereby said receiver can scan all available frequencies seeking a matching ID as well as said Color channel.
